(19) United States
(12) Patent Application Publication
(10) Pub. No.: US 2003/0119629 A1
(43) Pub. Date: Jun. 26, 2003

(54) Motor vehicle with a multiple-clutch multiple-speed transmission

(75) Inventor: Jochen Kuhstrebe, Biebelried/Westheim (DE)

Correspondence Address: COHEN, PONTANI, LIEBERMAN & PAVANE, 551 FIFTH AVENUE, SUITE 1210, NEW YORK, NY, 10176, US

(73) Assignee: ZF Sachs AG

(21) Appl. No.: 10/317,691

(22) Filed: Dec. 12, 2002

(30) Foreign Application Priority Data
Dec. 21, 2001 (DE) 101 63 401.3

(51) Int. Cl. F16H 61/04; B60K 41/02; B60K 41/24; B60K 41/28

(52) U.S. Cl. 477/77

(57) ABSTRACT

In a motor vehicle with a drivetrain having a multiple-clutch transmission, particularly a dual clutch device, and a corresponding transmission, an associated control device allocates different shifting forces or shifting force curves to occurring shift demands based on at least one of input data, operating states of the transmission, operating states of the clutch device, operating states of the drive unit, and driving states of the motor vehicle. By means of the actuating mechanism associated with or belonging to the transmission, respective gears are engaged with the respective associated shifting force or the respective associated shifting force curve and/or respective gears are released with the respective associated shifting force or with the respective associated shifting force curve.

### BACKGROUND OF THE INVENTION

1. Field of the Invention

The invention is directed to a motor vehicle with a multiple-clutch multiple-speed transmission, particularly a dual clutch multiple-speed transmission. More specifically, the invention relates to a motor vehicle with a drivetrain having a drive unit, a transmission with a first and a second transmission input shaft and a multiple-clutch device, particularly a dual clutch device, with a first clutch arrangement associated with the first transmission input shaft and a second clutch arrangement associated with the second transmission input shaft for transmitting torque between the drive unit and the transmission. A control device is provided by which gears of the transmission can be engaged and released in association with one of the first and second transmission input shafts by means of an actuating mechanism associated with or belonging to the transmission, and the clutch arrangements can be actuated by means of an actuating mechanism associated with or belonging to the clutch device. The invention is further directed to a method for shifting a multiple-clutch transmission, particularly a dual clutch transmission, and to a corresponding control device.

2. Description of the Related Art

Variably adjustable shifting forces for engaging and releasing gears of a transmission are already known, per se, in the prior art in connection with single-clutch transmissions. The primary use of adjustable variability is relief of the synchronizing devices of the transmission so as to prevent premature wear. In automated single-clutch shift transmissions (ASG), series manufacture of transmission actuating mechanisms with variably adjustable shifting forces has already been introduced. The following references can be cited from the prior art by way of example:

U.S. Pat. No. 5,910,068 discloses varying the shifting force when engaging gears and applying low shifting force during the actual synchronizing phase.

U.S. published application no. 2001/032523 discloses taking into account the frequency of gear shifts (the number of shifting processes that have taken place) and the inclination of the road in determining the shifting force in certain gears.

DE 199 61 117 A1 (=WO 01/44697) discloses switching the shifting force between a low shifting force curve and a high shifting force curve depending on the operating state of the motor vehicle.

DE 199 41 011 A1 suggests the variable adjustment of the releasing force for releasing a clutch member and determination of the magnitude of the releasing force depending upon the torque transmitted at the gear shift to be initiated and/or upon the speed of change of this torque.

There has been great interest recently in multiple-clutch and dual-clutch devices with a first clutch arrangement associated with a first transmission input shaft and a second clutch arrangement associated with a second transmission input shaft. This is because they offer driving comfort similar to that of a fully automatic transmission with a torque converter, but are more energy-efficient. Overlap shifting, as it is called, enables sequential shifting between gears without interruption of tractive force. In so doing, a gear is engaged additionally in association with a transmission input shaft that is not currently transmitting load when the associated clutch arrangement is not engaged. The clutch arrangement associated with the currently engaged load-transmitting gear (initial or starting gear) and the clutch arrangement associated with the additionally engaged gear (target gear) are then actuated opposite to one another in mutually adapted manner, namely, the clutch arrangement associated with the starting gear is released and the clutch arrangement associated with the target gear is engaged in a synchronized manner.

### SUMMARY OF THE INVENTION

The invention relates to variably adjustable shifting forces in dual-clutch transmissions (multiple-clutch transmissions in general). In particular, the actuating mechanism associated with or belonging to the transmission is designed for exerting variably adjustable shifting forces on shifting members of the transmission, and the control unit is designed to allocate different shifting forces or shifting force curves to the occurring shift demands based on input data and/or operating states of the transmission and/or operating states of the clutch device and/or operating states of the drive unit and/or driving states of the motor vehicle. By means of the actuating mechanism associated with or belonging to the transmission, respective gears are engaged with the respective associated shifting force or the respective associated shifting force curve and/or released with the respective associated shifting force or with the respective associated shifting force curve. It is primarily intended that the control unit is designed to allocate low shifting forces or shifting force curves with lower shifting forces to first shift demands and to allocate higher shifting forces or shifting force curves with higher shifting forces to second shift demands.

By means of the variably adjustable shifting forces, the synchronizing devices of the transmission can be relieved on the one hand and, on the other hand, a subjectively sufficient reaction speed on the part of the driver with respect to transmission actuation is provided. For this purpose, it is especially suggested that the first shift demands are those not occurring as an immediate reaction to an action on the part of the driver upon an operating control arrangement of the vehicle. The shift demands which are to be identified as first shift demands can occur, for example, in a fully automatic mode, e.g., in a D-operating state of the fully automatic function without any action on the part of the driver.

Preferably, the second shift demands are those which occur as an immediate reaction to an action by the driver on the operating control arrangement in the vehicle. The shift demands to be identified as second shift demands can likewise be shift demands which occur in a fully automatic mode, for example, when the accelerator pedal is pressed down sharply (kickdown). In such cases, the driver expects a spontaneous reaction of the automatic system of the transmission, for which reason, according to this suggested further development, higher shifting forces or shifting force curves with higher shifting forces are associated with the respective shift demands.

In particular, the second shift demands can also comprise shift demands that are communicated by the driver by means of an operating control arrangement as an express desired shifting. By this is meant, for example, shift demands occurring in a fully automatic mode or in a manual mode, e.g., driver commands for sequential further shifting of the transmission. This refers to a manner of shifting the transmission that is known within technical circles by the term “Tiptronic”, where the driver operates a shift lever or the gear selector lever arranged in an extra slot, for instance (see, e.g., U.S. Pat. No. 6,363,805).

In order to prepare for overlap shifting, in which a starting gear is engaged in association with a currently load-transmitting transmission input shaft and a target gear is engaged simultaneously in association with a transmission input shaft that is not currently transmitting load and then the clutch arrangement associated with the previously load-transmitting transmission input shaft is actuated so as to be released and the clutch arrangement associated with the transmission input shaft which was not previously transmitting load is actuated so as to be engaged, the control device can advantageously be designed for determining a probable target gear based on input data and engaging this target gear in association with the transmission input shaft not currently transmitting load as the potential target gear in addition to a gear (hereinafter: starting gear) which is engaged in association with the currently load-transmitting transmission input shaft and which represents the starting gear of the overlap shifting to be provided.

DE 199 37 716 C1 discloses an electronic control device associated with the transmission as a “gear predicting and gear preselection device” by means of which it can be predicted based on current operating data, before a gear change is demanded, whether it is probable that a gear change will be demanded and which gear will be probably selected. When a gear change appears probable the control device then engages this gear change by means of the transmission actuating mechanism to prepare for overlap shifting. According to the description in the above-cited patent, the following possible decisions exist for the control device depending on the operating data for the gear predicting and gear preselecting function of the control device: no prediction possible; or high probability for shifting up (from a lower starting gear to a higher target gear); or high probability for shifting down (from a higher starting gear to a lower target gear). For related prior art, see DE 40 31 852 A1, U.S. Pat. No. 5,915,512, DE-PS 923 402, DE 197 51 456 A1, and the technical journal “Automotive Engineering”, February 1983, 80-82.

DE 199 37 716 C1does not contain any further information concerning the way in which the operating data are evaluated or how the probabilities mentioned therein are determined from the various operating data mentioned in the patent.

Even though it is left up to the person skilled in the art to flesh out the teaching of DE 199 37 716 C1, the intention upon which the suggestion set forth in the patent is based is still useful. That is, in a multiple-clutch transmission, particularly a dual clutch transmission, it is desirable for various reasons to “predict” the actions of a driver and, based on this knowledge, to engage already the next gear desired by the driver. The overlap shifting can then be initiated immediately without a time delay when a shifting command is given by the driver (for example, manually by actuating by a gear selector lever or shift lever or by depressing the accelerator pedal to initiate so-called kickdown shifting). The driver expects a spontaneous reaction of the vehicle precisely during kickdown shifting, which can only be realized when the next lowest gear is already engaged.

Situations in which the driver desires spontaneous acceleration requiring backshifting are, for example, when the driver has already driven behind a slow moving vehicle for a long period of time at a relatively constant speed and wants to make use of a favorable traffic situation for passing.

To this extent, DE 199 37 716 C1 points in the right direction, but lacks suggestions as to how the “correct” target gear is actually to be predicted based on the input data.

With respect to preparation for overlap shifting for changing to a lower gear, it would be conceivable to preferably engage the next lowest gear as potential target gear so as to be able to react spontaneously in the event of backshifting errors.

However, this kind of “leading” of a lower gear is not always the correct choice because in the event of an “unexpected” command to shift up, the leading gear would first have to be disengaged and the desired higher gear engaged, which would lead to an inertia of the system that is clearly noticeable for the driver.

Further, with a leading of a lower gear, the transmission-side half of the respective clutch arrangement and all of the associated wheels and shafts of the transmission rotate faster relative to the gear of the closed (load-transmitting) clutch arrangement until the lower gear is additionally engaged and they must therefore also be accelerated or braked at the same time during each acceleration process, which is disadvantageous with respect to energy efficiency. Further, the speed of the engaged gear would have to be monitored in order to prevent damage and the engaged gear would have to be released again when a threshold speed is exceeded. When falling below the limit time again, the potential (lower) target gear would have to be engaged again so as to enable a spontaneous response to a possible backshift command.

In contrast, it is particularly preferable when the control device is designed to detect an increased probability for shifting down to a target gear lower than the starting gear based on the use of a directional signal and/or based on a steering actuation exceeding a minimum actuation and to engage a corresponding gear as potential target gear by means of the actuating mechanism.

According to one aspect, this suggested further development is based on the idea that the driver, provided he responds as prescribed by traffic rules, first makes an intended passing process known to the drivers of other vehicles, particularly of the vehicle ahead of him which he passes and to any vehicle behind him, by using a directional signal and actually initiates the passing process after using the directional signal by actively backshifting or by depressing the accelerator pedal.

This information, which is given to the drivers of other vehicles in traffic and which could be registered by a sensor or a control unit and conveyed to the control device, can be evaluated by the control device which can derive an increased probability of an impending command to backshift to a lower gear from this information and engage a correspondingly lower gear as potential target gear in order to be able to react spontaneously to the expected backshift command.

Further to the example of a passing maneuver, this is generally initiated by a fast, comparatively sharp steering movement. Therefore, according to another aspect, it is suggested that the steering movements of the driver are evaluated in a corresponding manner to derive from them an increased possibility, as the case may be, for an impending command to shift back to a lower gear. It is intended primarily that the control device is designed to detect the increased probability of downshifting based on a steering angle exceeding a minimum steering angle and/or based on a steering angle speed exceeding a minimum steering angle speed.

It is suggested in a further development that the control device is designed to partially engage the clutch arrangement associated with the transmission input shaft that was not previously transmitting load by means of the actuating mechanism associated with the clutch device for preparation for overlap shifting, preferably until a friction limit is reached. The respective clutch arrangement can be engaged, for example, until it just transmits a slight torque or even no torque. Because of this “preparatory” engagement of the clutch arrangement, a backshift command can be responded to immediately and the overlap shifting can be carried out without first having to bring the clutch arrangement associated with the target gear into a “starting position”.

The control device can advantageously be designed to check the reliability or usefulness of engaging a target gear that is lower that the starting gear and, only in the affirmative case, to engage a corresponding gear as potential target gear in response to the switching on of the directional signal or in response to the steering actuation exceeding the minimum actuation based on current and/or past driving states and/or based on navigation data and/or based on actuation states depending on actuation carried out by the driver and/or based on states of the transmission and/or the drive unit and/or the clutch device and/or based on other states of the motor vehicle. Diverse circumstances can be taken into account in this connection. For example, the control device should allow engagement of a lower gear only when speed thresholds, e.g., of the drive unit (engine) are not exceeded during backshifting.

Further, the control device can be designed corresponding to the suggestions in the above-cited patent DE 199 37 716 C1. The disclosure of this patent is incorporated in its entirety in the disclosure of the present application by reference.

In connection with the preparatory engagement of a potential target gear, it is particularly preferable, according to the invention, that the control device is designed for engaging the potential target gear by means of the actuating mechanism associated with or belonging to the transmission for purposes of a first shift demand with a lower shifting force or a shifting force curve with lower shifting forces.

In practice, it happens at least occasionally that the target gear which is actually required does not correspond to the potential target gear that has already been engaged. In this case, the anticipated gear that had already been engaged must be released again and the “correct” target gear must then be engaged, which results in correspondingly longer shifting times. In order to keep these shifting times within limits, the control device can be designed so that, when there is a shift demand according to which a target gear other than the engaged potential target gear is to be engaged by means of the actuating mechanism associated with or belonging to the transmission, the control device releases the engaged potential target gear according to a second shift demand with a higher shifting force or with a shifting force curve with higher shifting forces and engages the target gear corresponding to the occurring shift demand according to a second shift demand with a higher shifting force or with a shifting force curve with higher shifting forces by means of the actuating mechanism associated with or belonging to the transmission. In this connection, however, “urgent” shift demands, e.g., shift demands initiated immediately by an action of the driver, can also still be distinguished from less “urgent” shift demands, e.g., not deriving from an action of the driver, so that the higher shifting forces or shifting force curves with higher shifting forces are used only in case of “urgent” shift demands.

After overlap shifting is carried out, there will generally be sufficient time available to release the starting gear, should this be necessary. Accordingly, it is suggested that the control device is designed so that after carrying out overlap shifting the control device releases the starting gear for purposes of a first shift demand with a lower shifting force or with a shifting force curve with lower shifting forces by means of the actuating mechanism associated with or belonging to the transmission.

The control device can advantageously be designed so that when the motor vehicle is stationary and/or during driving states of the motor vehicle at a vehicle speed not exceeding a threshold value, the control device identifies all occurring shift demands as first shift demands and/or checks the occurring shift demands for usefulness and only engages a respective gear or releases a respective gear for shift demands which are identified as useful.

The idea is, for example, to entirely ignore senseless shift demands, e.g., when the vehicle is stationary. As a rule, it is useful to allow shifting only in starting gears and to ignore all other shift demands. Provided the shift demands are meaningful, it is generally sufficient to carry out these shift demands with small shifting forces.

Senseless shift demands can occur, for example, when a bored driver willfully plays around with the shift lever or the like while waiting at a traffic light, for example, in time with the music from a car radio. Wild, uncoordinated shifting in the transmission can be prevented according to the suggested further development. While uncoordinated shifting of this kind does not necessarily cause severe wear in the synchronizing devices because the transmission shafts do not rotate while the vehicle is stationary, other components such as shift forks, sleeves, etc. may nevertheless be stressed unnecessarily.

It has already been stated, at least implicitly, that the control device can be designed for carrying out gear changes automatically or fully automatically depending on input data by means of the actuating mechanism associated with or belonging to the transmission. In this respect, it can be provided that the control device provides a fully automatic mode in which the gear changes are carried out fully automatically depending on driving states and/or operating states of the vehicle. Further, the control device can provide a manual mode in which the gear changes are carried out depending on shift commands given by the driver by means of an operating control arrangement.

The invention is further directed to a control device for a motor vehicle according to the invention. It is suggested that a control device associated with the transmission is designed to assign different shifting forces or shifting force curves to occurring shift demands based on input data and/or operating states of the transmission and/or operating states of the clutch device and/or operating states of the drive unit and/or driving states of the motor vehicle and, by means of an actuating mechanism associated with or belonging to the transmission, to engage respective gears with the respective assigned shifting force or the respective assigned shifting force curve and/or to release respective gears with the respective assigned shifting force or the respective assigned shifting force curve. The control device according to the invention can be constructed corresponding to the control device of the motor vehicle according to the invention in the manner described above.

The invention is further directed to a method for shifting a multiple clutch transmission, particularly a dual clutch transmission. It is suggested that different shifting forces or shifting force curves are assigned to occurring shift demands based on input data and/or operating states of the transmission and/or operating states of the clutch device and/or operating states of the drive unit and/or driving states of the motor vehicle and respective gears with the respective assigned shifting force or the respective assigned shifting force curve are engaged and/or respective gears with the respective assigned shifting force or the respective assigned shifting force curve are released by means of an actuating mechanism associated with or belonging to the transmission. Advantageous further developments of the method according to the invention are given in the following. The invention will be described more fully in the following with reference to embodiment examples shown in the drawings.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings arc not necessarily drawn to scale and that, unless otherwise indicated, they are merely intended to conceptually illustrate the structures and procedures described herein.

### BRIEF DESCRIPTION OF THE DRAWINGS

FIG. 1 is a schematic view showing a motor vehicle drivetrain with a multiple-plate dual clutch and a power shift transmission having a control unit according to the invention;

FIG. 2 is a schematic view showing a modification of the drivetrain according to FIG. 1 in which a dry dual clutch in a friction-disk type construction is provided instead of a wet multiple-plate dual clutch;

FIG. 3 shows an example of a flow chart illustrating the assignment of lower and higher shifting forces to shift demands; and

FIG. 4 shows a variant of the flow chart according to FIG. 3.

### DETAILED DESCRIPTION OF THE PRESENTLY PREFERRED EMBODIMENTS

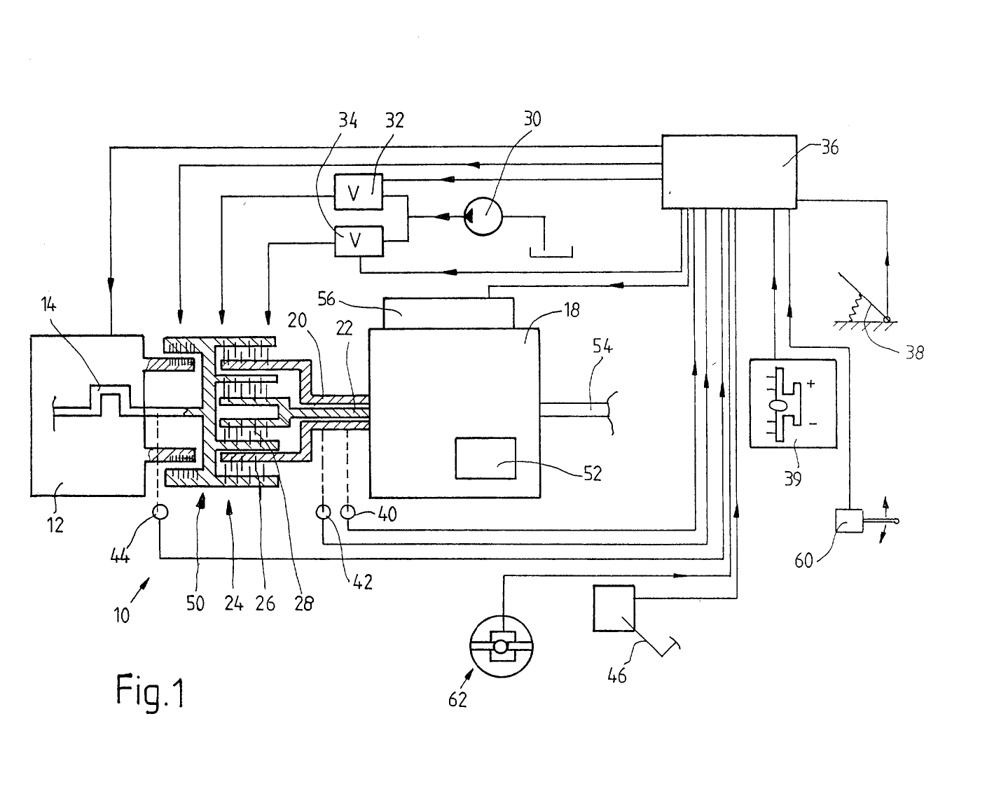

FIG. 1 shows an example of a drivetrain 10 of a motor vehicle. The drivetrain has a drive unit 12 in the form of an internal combustion engine as is indicated by a crankshaft 14 shown schematically. A power shift transmission 18 with two radially nested transmission input shafts 20 and 22 is connected to the engine 12 by a dual clutch 24. The dual clutch 24 comprises two clutch arrangements 26 and 28, one of which is associated with transmission input shaft 20, while the other is associated with transmission input shaft 22. The embodiment example concerns wet multiple-plate clutch arrangements which can be hydraulically actuated by a hydraulic slave cylinder (not shown) that is integrated in the dual clutch. A corresponding hydraulic pump 30 is shown schematically. A coolant oil circuit with a coolant oil pump, etc. associated with the dual clutch is not shown. Suitable dual clutch constructions are known, for example, from DE 100 04 179 A1.

The actuation of the two clutch arrangements is carried out through the intermediary of control valves 32 and 34 which are electrically controllable by a control unit 36. The control unit receives input signals from an accelerator pedal 38, a gear selecting unit and/or influencing unit 39, a speed sensor 40 associated with transmission input shaft 20, a speed sensor 42 associated with transmission input shaft 22, and a speed sensor 44 associated with the driven shaft (crankshaft 14) of the engine. Further, the control unit can receive additional signals and measurement values from other sensors and signal transmitters such as a vehicle speed sensor, a steering angle sensor, a brake actuation state sensor (of the brake pedal 46 shown in FIG. 1, for example), etc.

By comparing the speed of speed sensor 44 to the speed of speed sensor 40 or 42, the control unit can determine a slip state of clutch arrangement 26 and clutch arrangement 28. The control unit 36 controls a power output stage of the engine 12 for adjusting the output or torque delivered by the engine.

FIG. 1 shows a crankshaft starter generator 50 having a stator arrangement arranged at the engine 12 and a rotor arrangement arranged at the input side of the dual clutch 24. The crankshaft starter generator 50 is activated by the control unit 36, particularly in order to start the engine 12.

The power shift transmission 18, which can also be called a dual clutch transmission, is preferably a fully synchronized transmission with a corresponding synchronizing device 52. The synchronizing device 52 need not be a central synchronizing device for the entire transmission. The synchronizing device can also be formed of conventional synchronizing means, e.g., in the form of synchronizing rings. A driven shaft of the transmission is designated by 54. The transmission is preferably actuated in a fully automatic manner by means of an actuating device 56 which is controllable in a corresponding manner by the control unit 36. The driver can direct the control unit 36 to shift down to a lower gear or to shift up to a higher gear by means of the gear selector unit and/or influencing unit 39. In the fully automatic mode, the control unit 36 shifts automatically depending on driving states and operating states of the vehicle.

As a rule, shifting between a starting gear and a target gear is carried out by “overlap shifting”, as it is called, in that, in addition to the currently load-transmitting starting gear, the target gear is already engaged in association with the other transmission input shaft which does not currently transmit load, and the clutch arrangement associated with the transmission input shaft not transmitting load is released. During overlap shifting, the clutch arrangement which is associated with the starting gear and which is not transmitting a load at the moment and the clutch arrangement associated with the target gear are actuated simultaneously so as to be adapted to one another, the former being released and the latter being engaged, so that the drive torque of the drive unit is shifted from the transmission input shaft associated with the starting gear, and therefore from the starting gear, to the transmission input shaft associated with the target gear, and therefore to the target gear.

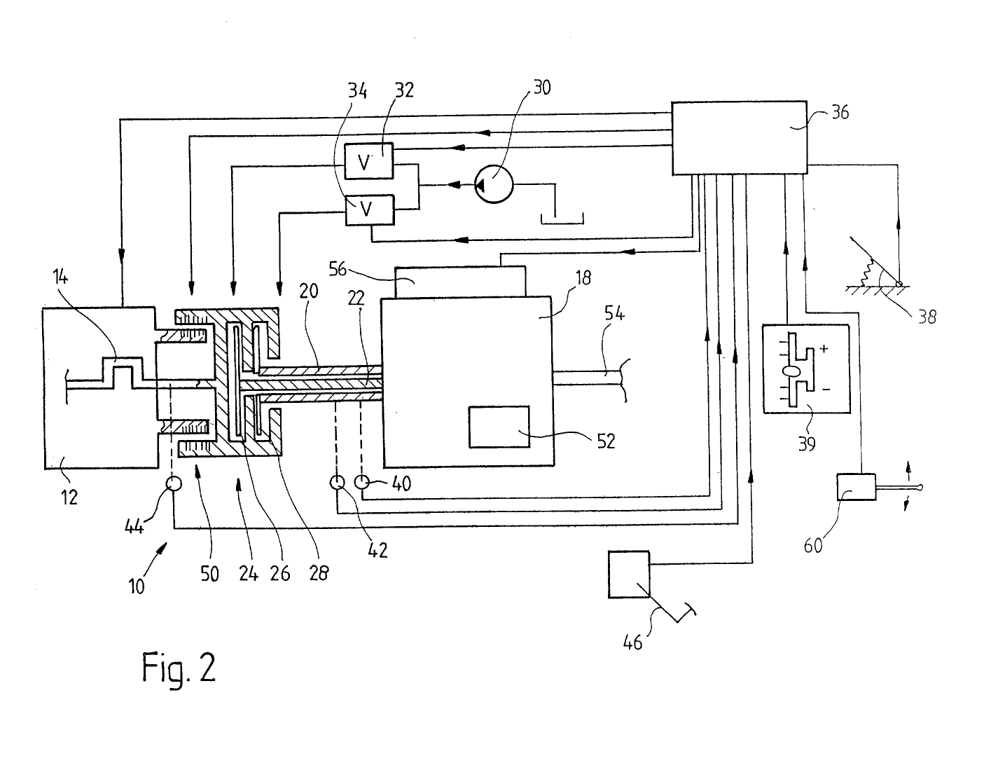

FIG. 2 shows another example of a drivetrain 10 of a motor vehicle. Only the differences with respect to the drivetrain according to FIG. 1 are shown. Instead of a dual clutch 24 with two concentric wet multiple-plate clutch arrangements 26 and 28, a dual clutch 24 is provided with two dry multiple-plate clutch arrangements 26 and 28 arranged coaxially in tandem. The two friction disk clutch arrangements can be hydraulically actuated, for example, by hydraulic slave cylinders integrated in the dual clutch, which is assumed in FIG. 2. Corresponding possible implementations are shown, for example, in U.S. Pat. No. 4,714,147. However, dry dual clutches of a completely different construction can also be used (see, e.g., EP 0 931 951 A1).

When the target gear is still engaged initially as the result of a manual shift command given by means of the unit 39 or as the result of the decision made in fully automatic mode by the control unit 36 for shifting by way of an overlap shift, delays which noticeably impair driving comfort can occur under some circumstances. For this reason, the control unit 36 is preferably constructed with a gear predicting function which predicts a probable target gear depending on input data and engages this target gear in preparation for an expected overlap shift, although no shift command has as yet been given by the unit 39 or no decision for shifting has been made in fully automatic mode. In this connection, the control unit 36 can be constructed corresponding to the gear predicting and gear preselection device suggested in DE 199 37 716 C1 and diverse operating data can be processed as input data. Reference is had to the disclosure of DE 199 37 716 C1 which is incorporated in its entirety by reference in the disclosure of the present patent application.

With respect to the preparation for downshifting to a lower gear, the control unit 36 is preferably specifically designed to detect an increased probability for downshifting to a target gear that is lower than the starting gear based on the operation of a directional signal and to engage a corresponding gear as potential target gear by means of the actuating device 56. Further, according to a preferred embodiment form, the control device is designed so that the clutch arrangement which is associated with the target gear that has already been engaged tentatively and which has not yet transmitted load is engaged partially, preferably until reaching a friction limit, by actuating the valve arrangement 32, 34 in a corresponding manner to prepare for the overlap shifting, so that the overlap shifting can be carried out immediately, i.e., without a time delay, after a shift command or after the decision to initiate a shifting process.

With respect to the anticipated engagement of a potential target gear that is lower than the current load-transmitting gear (starting gear) based on turning on the directional signal, it is provided in the embodiment examples shown in FIGS. 1 and 2 that a corresponding blinker control signal of a blinker switch 60 is supplied to the control unit 36 by itself or in addition. When the driver actuates the blinker switch 60 to signal a passing maneuver, the control unit 36 can detect the increased probability for an impending shifting to a lower target gear based on the blinker control signal sent to it and, in response, can engage the respective lower gear (the potential target gear).

It is generally sensible to assume an increased probability of the engagement of a target gear which is lower than the present gear when the driver actuates the blinker switch. Also, as a rule, during curving processes which should be announced by a corresponding directional signal according to traffic rules, either the present gear is retained or a lower gear is shifted to.

Alternatively or in addition, the control unit 36 can detect an increased probability of an impending shifting to a lower target gear based on steering movements and, as a response to this, can engage the respective lower gear (potential target gear). According to FIG. 1 (this can also be provided in a corresponding manner for the embodiment example in FIG. 2), the control unit 36 receives signals from a vehicle steering mechanism 62. It could be provided, for example, that an instantaneous steering angle or changes in the instantaneous steering angle (possibly a steering angle speed) are detected by a corresponding sensor and supplied to the control unit 36 in the form of corresponding signals. Since passing maneuvers are generally initiated in particular by a pronounced steering maneuver, the probability of an impending shift to the lower target gear for purposes of high vehicle acceleration can be detected from this steering maneuver with quite a high degree of accuracy.

The control unit can take various other input data into account for its prediction of a respective target gear. In so doing, the control unit can check the reliability or usefulness of engaging a predicted target gear and, possibly in spite of the presence of a prediction that a certain target gear will probably be activated next, can overlook the foreseen engagement of this gear as potential target gear. This checking for reliability or usefulness can also be carried out in particular with respect to a target gear that is lower than the starting gear, for example, in order to ensure that speed limits (e.g., of the drive unit which is preferably constructed as an internal combustion engine) are not exceeded when backshifting.

According to the invention, the control unit 36 is designed (1) to assign different shifting forces or shifting force curves to occurring shift demands depending on input data and/or operating states of the transmission and/or operating states of the clutch device and/or operating states of the drive unit and/or driving states of the motor vehicle and (2) to engage respective gears with the assigned shifting force or with the assigned shifting force curve (3) and/or to release respective gears with the assigned shifting force or with the assigned shifting force curves by means of the transmission actuating mechanism (valves 32, 34 and hydraulic slave cylinders associated with the clutch arrangements). As a rule, it is sufficient to distinguish between first or “less urgent” shift demands and second or “more urgent” shift demands and to assign lower shifting forces or shifting force curves with lower shifting forces to the first or “less urgent” shift demands and to assign higher shifting forces or shifting force curves with higher shifting forces to the second or “more urgent” shift demands.

When shifting in a fully automatic mode of the control unit 36 in which the driver expects shifting of the transmission but does not know their exact outcome, the control unit 36 responds to characteristic operating data such as increasing or decreasing engine speed and/or transmission speed. The control unit can then engage the next gear to be shifted with relatively low shifting forces. The correspondingly longer shifting duration caused by the relatively low shifting forces is not perceived by the driver as a time delay because the driver does not know when the shifting command was given. The lower shifting forces relieve the synchronizing devices of the transmission.

A variation in shifting forces in different automatic modes is possible in principle within the framework of the invention, but is not absolutely necessary, at least with overlap shafting, because there is no interruption in tractive force during overlap shifting.

However, unexpected shift demands in which the driver expects an immediate reaction of the vehicle, e.g., with kickdown of the accelerator pedal, can also occur in a fully automatic mode. When the required gear has been engaged in anticipation as a “potential target gear” corresponding to the suggestions indicated in the preceding, only the overlap shifting needs to be carried out.

On the other hand, in case of an unforeseen or incorrectly predicted shift command on the part of the driver, no gear or an incorrect gear (a higher gear in the example of kickdown) is engaged on the other transmission shaft that is not currently transmitting load. In the first case, the incorrect gear must be released first before the correct gear is engaged, as well as in the second case, so that overlap shifting can take place subsequently. The same is true for embodiment forms in which there is no anticipated engagement of transmission gears based on predictions or probabilities. With respect to shift demands of this kind, it is suggested that higher shifting forces are applied in order to engage the correct gear quickly. In the event that another, incorrect gear has to be released first, this should also be carried out as quickly as possible and a correspondingly high shifting force (releasing force) should be used.

However, insofar as potential target gears are engaged in an anticipatory manner, this can be carried out with low shifting forces because there is still no immediately imminent overlap shifting for the moment.

When shifting in manual mode, it is possible in the two embodiment examples shown in FIGS. 1 and 2 to distinguish primarily two types of shifting in which the flow of power is shifted from one transmission shaft to the other. On the one hand, shifting occurs in which the gear to be shifted must first be engaged on the other transmission shaft because there is no gear is engaged or the incorrect gear is engaged. Further, shifting occurs in which the correct gear (the potential target gear) is engaged on the other transmission shaft by way of precaution based on a corresponding prediction already prior to the shift command of the driver.

As was already mentioned with reference to the fully automatic mode, anticipated shifting to a potential target gear which is performed by means of the gear predicting device without an express shifting command should be carried out with low shifting forces because there is no particular urgency on the part of the driver in the absence of an express shift command. On the other hand, shift demands of the driver in which the selected gear is first engaged and, if necessary, an incorrect gear must even be released first must be actuated with comparatively high shifting force so as to implement the express shift command of the driver as quickly as possible. In a manual mode, the shift wishes of the driver can be predicted only with appreciably poorer results compared with potential shift demands in an automatic mode, so that compared with the automatic mode there would have to be more shift demands in which no gear or an incorrect gear is engaged on the other transmission input shaft.

It can be provided in fully automatic mode as well as in manual mode that different variable shifting forces are used within one shift (see U.S. Pat. No. 5,910,068).

According to the preceding suggestions, when high shifting forces are applied only when needed for engaging and releasing gears and comparatively low shifting forces are used otherwise, wear on the synchronizing devices of the transmission is minimized as a whole, specifically under the boundary condition that the subjective response speed of the system from the driver's point of view is not worsened or is not substantially worsened. When the higher shifting forces are correspondingly great, the system reacts sufficiently quickly from the driver's point of view. The higher shifting forces themselves can also be a compromise between shifting speed and loading of the synchronizing devices. However, due to the reduced loading of the synchronizing devices by the weaker shifting forces, the burden of this compromise falls somewhat more on the shorter shifting times.

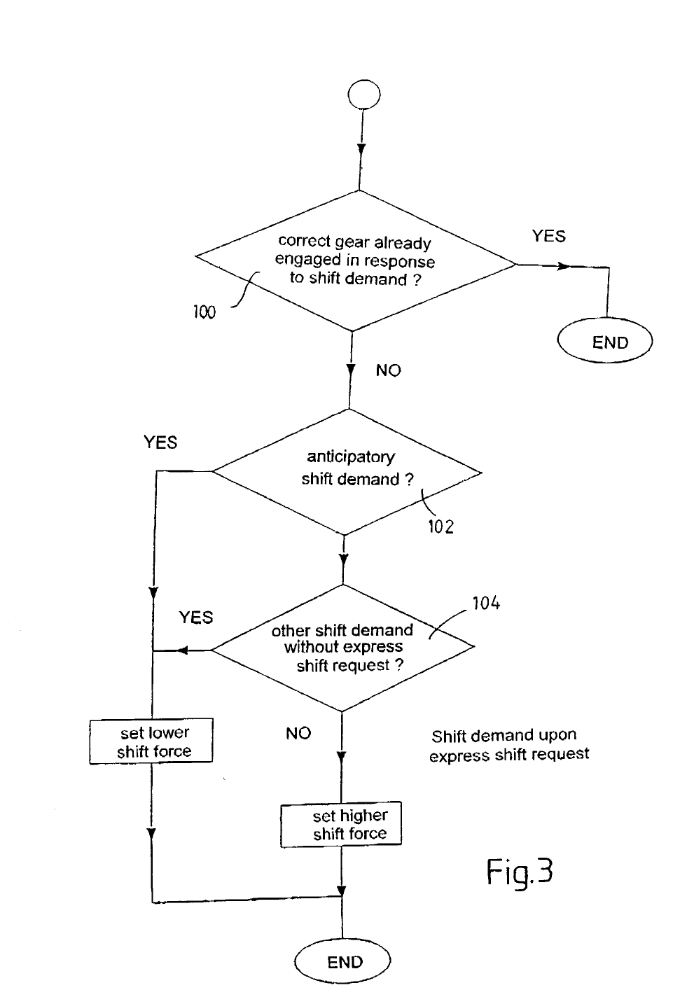

FIG. 3 shows an example of a flow chart of a routine or a part of a routine which takes place in the control unit 36 and assigns a respective shifting force to shift demands. The shift demands can involve the release of gears as well as the engagement of gears. In 100, a check is carried out as to whether the correct gear has already been engaged with respect to a shift demand. If yes, no further shifting is needed with respect to the transmission; only the overlap shifting needs to be carried out by corresponding actuation of the clutch arrangements. The routine can accordingly be terminated.

In 102, a check is made as to whether or not an anticipated shift demand is involved. If yes, the shift demand is not urgent and can be carried out with a lower shift force. If no anticipated shift demand is involved, i.e., no shift demand that is initiated by the gear predicting function of the control unit 36, a check is made in 104 as to whether another shift demand is involved without any express shift command on the part of the driver. If yes, a lower shifting force is likewise used. However, if this involves a shift demand in response to an express shift command on the part of the driver, higher shifting force is used. Insofar as this is the case, the higher shifting force is used on the one hand as a releasing force for releasing an erroneously engaged potential target gear and also as an engaging force for engaging the target gear corresponding to the shift command.

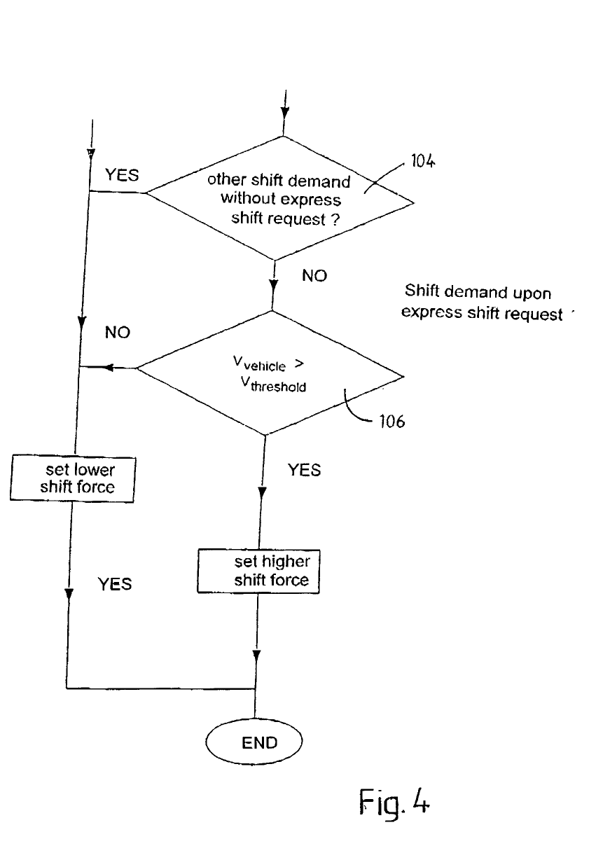

According to the example in FIG. 4, it can also be provided that the vehicle speed is compared (at 106) to a threshold speed and that the higher shifting force is used only for vehicle speeds exceeding the speed threshold. Another check concerning basic reliability or usefulness of shift demands can also be integrated in the sequence. For example, it is generally useful to allow shifting only in starting gears when the motor vehicle is stationary and to ignore further shift demands. Unnecessary shifting of the transmission owing to a driver's arbitrary (playful) actuation of the shift lever, for example (e.g., to pass time while waiting at a traffic light) can be reliably prevented in this way.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A drive train for a motor vehicle, said drive train comprising:
a drive unit;
a transmission having a first input shaft, a second input shaft, gears associated with said input shafts, and shifting members for engaging and releasing said gears;
a transmission actuating mechanism which exerts variably adjustable shifting forces on said shifting members in response to occurring shift demands;
a clutch device comprising a first clutch arrangement associated with the first transmission input shaft and a second clutch arrangement associated with the second input shaft for transmitting torque between the drive unit and the transmission;
a clutch actuating mechanism for actuating said clutch arrangements; and
a control device which allocates different shifting forces or shifting force curves to said shift demands based on at least one of input data, operating states of the transmission, operating states of the clutch device, operating states of the drive unit, and driving states of the motor vehicle.

2. A drive train as in claim 1 wherein said control device recognizes first and second shift demands and allocates higher shifting forces or shifting force curves to said second shift demands than to said first shift demands.

3. A drive train as in claim 2 wherein said first shift demands are those not occurring as an immediate reaction to an action by the driver on an operating control of the vehicle.

4. A drive train as in claim 2 wherein said second shift demands are those which occur as an immediate reaction to an action by the driver on an operating control of the vehicle.

5. A drive train as in claim 2 wherein said second shift demands comprise shift demands that are communicated by the driver by means of an operating control as an express desired shift demand.

6. A drive train as in claim 1 wherein said control device is designed to execute overlap shifting, wherein one of said input shafts is transmitting a load and a gear associated with said one of said shafts is engaged as a starting gear, and the other of said input shafts is not transmitting a load and a gear associated with the other of said shafts is simultaneously engaged as a target gear, said control device executing said overlap shifting according to the following steps:
determining a target gear based on input data;
engaging said target gear;
releasing said clutch arrangement associated with said one of said input shafts; and
engaging said clutch arrangement associated with the other of said input shafts.

7. A drive train as in claim 6 wherein said target gear is determined to be lower than said starting gear based on input data including at least one of use of a directional signal and a steering actuation exceeding a minimum actuation, and said target gear is engaged via said transmission actuating mechanism.

8. A drive train as in claim 7 wherein said target gear is determined to be lower than said starting gear based on input data including at least one of a steering angle exceeding a minimum steering angle and a steering angle speed exceeding a minimum steering angle speed.

9. A drive train as in claim 7 wherein said control device partially engages the clutch arrangement associated with the other input shaft via said clutch actuating mechanism until a friction limit is reached.

10. A drive train as in claim 7 wherein, when said target gear is determined to be lower than said starting gear based on use of a directional signal, said target is engaged based on at least one of current driving states, past driving states, navigation data, actuation states effected by the driver, states of the transmission and states of the clutch device.

11. A drive train as in claim 6 wherein said control device recognizes first and second shift demands and allocates higher shifting forces or shifting force curves to said second shift demands than to said first shift demands, said control device engaging said target gear via said transmission actuating mechanism according to a first shift demand.

12. A drive train as in claim 6 wherein said control device recognizes first and second shift demands and allocates higher shifting forces or shifting force curves to said second shift demands than to said first shift demands, and wherein, when there is a shift demand according to which a target gear other than the engaged target gear is to be engaged, said engaged target gear is disengaged according to a second shift demand, and the target gear other than said engaged target gear is engaged according to a second shift demand.

13. A drive train as in claim 6 wherein said control device recognizes first and second shift demands and allocates higher shifting forces or shifting force curves to said second shift demands than to said first shift demands, and wherein said clutch arrangement associated with said one of said input shafts is released according to a first shift demand.

14. A drive train as in claim 2 wherein said control device is designed so that, when said motor vehicle does not have a speed exceeding a threshold value, the control device recognizes all shift demands as first shift demands.

15. A drive train as in claim 2 wherein said control device is designed so that, when said motor vehicle does not have a speed exceeding a threshold value, the control device checks the shift demands for usefulness and only engages or releases a gear for shift commands which are identified as useful.

16. A drive train as in claim 1 wherein said control device executes gear changes automatically via said transmission actuating mechanism.

17. A drive train as in claim 1 wherein said control device executes gear changes fully automatically based on at least one of driving states and operating states of the vehicle.

18. A drive train as in claim 1 wherein said control device has a manual mode wherein said gear changes are executed based on shift commands given by the driver via an operating control.

19. A control device for a drive train of a motor vehicle, said drive train comprising a drive unit; a transmission having a first input shaft, a second input shaft, gears associated with said input shafts, and shifting members for engaging and releasing said gears; a transmission actuating mechanism which exerts variably adjustable shifting forces on said shifting members in response to occurring shift demands; a clutch device comprising a first clutch arrangement associated with the first transmission input shaft and a second clutch arrangement associated with the second input shaft for transmitting torque between the drive unit and the transmission; and a clutch actuating mechanism for actuating said clutch arrangements; said control device allocating different shifting forces or shifting force curves to said shift demands based on at least one of input data, operating states of the transmission, operating states of the clutch device, operating states of the drive unit, and driving states of the motor vehicle.

20. A method for shifting a transmission in a drive train of a motor vehicle, said transmission having a first input shaft, a second input shaft, gears associated with said input shafts, and shifting members for engaging and releasing said gears via an actuating mechanism which exerts variably adjustable shifting forces on said shifting members in response to occurring shift demands, said method comprising allocating different shifting forces or shifting force curves to said shift demands based on at least one of input data, operating states of the transmission, operating states of the clutch device, operating states of the drive unit, and driving states of the motor vehicle.
